(19) United States
(12) Patent Application Publication
(10) Pub. No.: US 2006/0140436 A1
(43) Pub. Date: Jun. 29, 2006

(54) Method and system for assembling electroacoustic transducers

(76) Inventors: Jeroen Anthonius de Moel, Amsterdam (NL); Jan Hijman, De Bilt (NL); Philip Lodewijk Pieter Baron van der Borch tot Verwolde, Amsterdam (NL); Stephan Olivier van Banning, Ijmuiden (NL)

Correspondence Address: JENKENS & GILCHRIST, P.C., 225 WEST WASHINGTON, SUITE 2600, CHICAGO, IL, 60606, US

(21) Appl. No.: 11/023,266

(22) Filed: Dec. 27, 2004

(51) Int. Cl. H04R 9/06

(52) U.S. Cl. 381/396

(57) ABSTRACT

Method and system are disclosed for facilitating automatic assembly of electroacoustic transducers for listening devices, such as hearing aids. The method and system provide the components of the electroacoustic transducer in the form of carriers. Each carrier includes a frame surrounding a preformed component. The preformed component is attached to the frame by at least one strut that holds the component in a fixed position within the frame. The frame may then be used as a guide or reference for mounting other components (whether provided on component carriers or not) to the preformed component. Some components, instead of being in a carrier, may be preassembled as a subassembly and then mounted to other components that are in a carrier. Several carriers may be connected sequentially in a strip and run through an assembly line to facilitate automatic assembly of multiple electroacoustic transducers in parallel.

### FIELD OF THE INVENTION

The present invention relates to miniature electroacoustic transducers used in listening devices, such as hearing aids. In particular, the present invention relates to a method and system for assembling such miniature electroacoustic transducers.

### BACKGROUND OF THE INVENTION

A conventional listening device such as a hearing aid includes, among other things, a microphone and a receiver (generally referred to as electroacoustic transducers). The microphone collects sound waves and converts the sound waves to an electrical signal. The electrical signal is then processed (e.g., amplified) and provided to the receiver. The receiver converts the processed electrical signal into an acoustic signal and subsequently broadcasts the acoustic signal to the eardrum.

A typical receiver includes, among other things, a housing that protects the sensitive components inside the receiver. The housing is of a sufficiently small size and shape that allows the receiver to be used in miniature listening devices, such as hearing aids. Mounted within the housing is an electromagnetic drive that converts electrical signals from a microphone into acoustic signals. The electromagnetic drive includes an armature and an electrically conductive coil through which the electrical signals from the microphone pass. Lead wires from the coil extend through an opening in the housing and terminate at a terminal on the outside of the receiver. A magnet assembly in the electromagnetic drive holds a pair of magnets that define a magnetic gap through which the working portion of the armature extends.

In operation, an electrical signal passing through the coil induces a magnetic field around the armature. The armature is typically E-shaped, with a base from which three parallel legs extend. The middle leg, which is the moving part of the armature, passes through the center of the coil along a central axis thereof, while the outer legs extend along the outside of the coil. The ends of the outer armature legs are then attached to the magnet assembly, which is adjacent to the coil. Variations in the electrical signal produce fluctuations in the magnetic field, causing the middle armature leg to alternate between moving toward one or the other of the magnets in the magnet assembly. A diaphragm converts the armature movements, via a drive pin, into a corresponding acoustic signal that is then broadcast to the eardrum.

In prior art receivers, the electromagnetic drive and the housing are typically assembled manually. The armature, for example, is often mounted in the magnet assembly by hand using tweezers and other similar implements. Moreover, the receivers are usually assembled only one unit at a time, usually with a 5-sided case (four side walls and bottom cover), with the sixth (top cover) added later. In some cases, an external positioning system is required because the positions of certain components, for example, the armature in the magnet, must be very precise. An improperly positioned armature can damage the electromagnetic drive due to the deflections in the moving part of the armature. As a result, the process of assembling receivers of the kind used in listening devices has heretofore been very tedious and time-consuming.

Accordingly, what is needed is an improved way to assemble electroacoustic transducers, especially the kind used in listening devices. In particular, what is needed is a way to facilitate automatic assembly of such electroacoustic transducers.

### SUMMARY OF THE INVENTION

The present invention is directed to a method and system for facilitating automatic assembly of electroacoustic transducers for listening devices, such as hearing aids. The method and system of the invention provide the components of the electroacoustic transducer in the form of carriers. Each carrier includes a frame surrounding a preformed component. The preformed component is attached to the frame by at least one strut that holds the component in a fixed position within the frame. The frame may then be used as a guide or reference for mounting other components (whether provided on component carriers or not) to the preformed component. Some components, instead of being in a carrier, may be preassembled as a subassembly and then mounted to other components that are in a carrier. Several carriers may be connected sequentially in a strip and run through an assembly line to facilitate automatic assembly of multiple electroacoustic transducers in parallel.

In general, in one aspect, the invention is directed to an electromagnetic drive component carrier suitable for a miniature electroacoustic transducer of a listening device. The electromagnetic drive component carrier comprises an electromagnetic drive component and a frame supporting the electromagnetic drive component, the frame having registration elements formed therein for registration of the component carrier with other component carriers. Struts are used to attach the electromagnetic drive component to the frame, the struts holding the electromagnetic drive component in a fixed position spaced apart from the frame.

In some embodiments, the electromagnetic drive component may be an armature, such as an E-shaped armature. In some embodiments, the frame includes an access area for allowing a coil assembly to be mounted on the E-shaped armature. It is also possible for the armature to be a U-shaped armature. In some embodiments, the electromagnetic drive component is a magnet shell. In some embodiments, the struts extend in a different direction for each type of electromagnetic drive components attached to the frame, or they may extend in a same direction for each type of electromagnetic drive components attached to the frame. In some embodiments, the electromagnetic drive component is in a plane that is substantially parallel to a plane of the frame. Also, a plurality of the component carriers may be connected together in series to form a strip of component carriers.

In general, in another aspect, the invention is directed to an electromagnetic drive suitable for an electroacoustic transducer of a miniature listening device. The electromagnetic drive comprises an armature having a moving end and a fixed end and a coil assembly mounted around the armature adjacent to the fixed end, the coil assembly inducing a magnetic field around the armature that corresponds to a current flowing through the coil assembly. The electromagnetic drive further comprises a magnet assembly mounted on the armature adjacent to the moving end, the magnet assembly magnetically interacting with the moving end of the armature. The armature has exposed cutting surfaces indicative of removal of struts that were previously attached to the armature.

In some embodiments, the cutting surfaces of the armature may be jagged, or they may be smooth. In some embodiments, the magnet assembly comprises a lower magnet shell, the lower magnet shell having exposed cutting surfaces indicative of removal of struts previously attached to the lower magnet shell. The magnet assembly may also comprise an upper magnet shell, the upper magnet shell having exposed cutting surfaces indicative of removal of struts previously attached to the upper magnet shell. The armature may be an E-shaped armature and the magnet assembly may define a gap in which a middle leg of the E-shaped armature may move.

In general, in yet another aspect, the invention is directed to a receiver suitable for a listening device. The receiver comprises a housing, a diaphragm mounted within the housing, and an electromagnetic drive assembly connected to the diaphragm, the electromagnetic drive assembly comprising an armature having exposed cutting surfaces indicative of removal of struts previously attached to the armature.

In some embodiments, the electromagnetic drive assembly further comprises a lower magnet shell mounted on the armature, the lower magnet shell having exposed cutting surfaces indicative of removal of struts previously attached to the lower magnet shell. The electromagnetic drive assembly may further comprise an upper magnet shell mounted on the armature, the upper magnet shell having exposed cutting surfaces indicative of removal of struts previously attached to the upper magnet shell. The housing may have a size and shape that allows the receiver to be used in miniature listening devices, including hearing aids.

In general, in still another aspect, the invention is directed to an assembly suitable for a working drive of an electroacoustic transducer. The assembly comprises a plurality of component carriers stacked directly adjacent to one another, each component carrier carrying a working drive component therein in a fixed position. The assembly further comprises means for registering the component carriers with one another so that each working drive component is in a desired location relative to an adjacent working drive component.

In some embodiments, the means for registering may include notches formed in the plurality of component carriers, and/or they may include protrusions formed in the plurality of component carriers. In some embodiments, the plurality of component carriers are in strips that are stacked directly adjacent to one another.

In general, in yet another aspect, the invention is directed to a method of assembling a working drive suitable for electroacoustic transducers of listening devices. The method comprises the step of providing a first component carrier, the first component carrier carrying a first working drive component therein at a fixed position. The method further comprises the step of placing the first component carrier directly adjacent to a second component carrier so that the first component carrier is in registration with the second component carrier, the registration causing a second working drive component carried by the second component carrier to be automatically aligned with the first working drive component. The first and second working drive components are then removed as a unit from the first and second component carriers.

In some embodiments, the method further comprises placing at least a third component carrier directly adjacent to the first component carrier so that the third component carrier is in registration with the first component carrier, the registration causing a third working drive component carried by the third component carrier to be automatically aligned with the first working drive component. In some embodiments, the working drive is an electromagnetic drive and the first component carrier is an armature carrier, the second component carrier is a lower magnet shell carrier, and the third component carrier is an upper magnet shell carrier. In some embodiments, the step of placing the first component carrier directly adjacent to the second component carrier results in the first and second component carriers being in physical contact with one another.

In some embodiments, the method further comprises pre-assembling a working drive subassembly and mounting the preassembled working drive subassembly on the first working drive component. The step of providing the first component carrier may comprise providing a strip of first component carriers. The step of placing the first component carrier on top of the second component carrier may comprise placing a strip of first component carriers on top of a strip of second component carriers. In some embodiments, the registration may comprise a notch in the first component carrier being aligned with a notch in the second component carrier.

The step of removing the first and second working drive components may comprise stamping the first and second working drive components as a unit from the first and second carriers. The step of removing the first and second working drive components may comprise laser cutting the first and second working drive components from the first and second carriers. The step of removing the first and second working drive components may leave exposed cutting surfaces on the first and second working drive components indicative of struts attaching the first and second working drive components to the first and second carriers, respectively.

In general, in still another aspect, the invention is directed to a method of assembling an electromagnetic drive suitable for miniature listening devices. The method comprises to step of providing an armature carrier, the armature carrier carrying an armature therein at a fixed position. The method further comprises the step of placing the armature carrier on top of a lower magnet shell carrier so that the armature carrier is in registration with the lower magnet shell carrier, the registration causing a lower magnet shell carried by the lower magnet shell carrier to be properly positioned on the armature. An upper magnet shell carrier is stacked on top of the armature carrier so that the upper magnet shell carrier is in registration with the armature carrier, the registration causing an upper magnet shell carried by the upper magnet shell carrier to be properly positioned on the armature. The armature, the lower magnet shell, and the upper magnet shell are then singulated as a unitary piece from the armature carrier, the lower magnet shell carrier, and the upper magnet shell carrier. The singulation leaves exposed cutting surfaces on the armature, the lower magnet shell, and the upper magnet shell that are indicative of struts used to attach the armature, the lower magnet shell, and the upper magnet shell to the armature carrier, the lower magnet shell carrier, and the upper magnet shell carrier, respectively.

In general, in yet another aspect, the invention is directed to a method of assembling an electroacoustic transducer suitable for listening devices. The method comprises the step of providing a first component carrier, the first component carrier carrying a first transducer component therein at a fixed position. The method further comprises the step of registering a second transducer component relative to the first transducer component by aligning a second component carrier that carries the second transducer component to the first component carrier. The first and second transducer components are then removed from the first and second component carriers, respectively.

In general, in still another aspect, the invention is directed to a method of assembling electromagnetic drive components suitable for an electromagnetic drive of a miniature listening device. The method comprises the step of sandwiching an armature between a first magnet shell and a second magnet shell, wherein at least the first magnet shell is provided in a first magnet shell carrier that holds the first magnet shell in a fixed position in the carrier. The method further comprises the step of securing the armature to the first magnet shell and the second magnet shell to form a single assembly.

In some embodiments, the step of securing the armature to the first magnet shell and the second magnet shell may include adhering the armature to the first magnet shell and the second magnet shell, or it may include laser welding the armature to the first magnet shell and the second magnet shell. In some embodiments, the method may further comprise forming an opening in the armature to partially expose a contact area between the armature and the first magnet shell to the laser welding, and/or singulating the assembly to remove the first magnet shell carrier from the assembly. In some embodiments, the method may further comprise providing the second magnet shell in a second magnet shell carrier that holds the second magnet shell in a fixed position, and/or providing the armature in an armature carrier that holds the armature in a fixed position.

In general, in yet another aspect, the invention is directed to an electromagnetic drive assembly for an electromagnetic drive of a miniature listening device. The assembly comprises a first magnet shell carrier carrying a first magnet shell at a fixed position therein, and a second magnet shell carrier carrying a second magnet shell at a fixed position therein. The assembly further comprises an armature sandwiched between the first and second magnet shells of the first and second magnet shell carriers such that the first and second magnet shell carriers are in registration with each other and with the armature.

In some embodiments, the armature is an E-shaped armature with a pair of outer legs and an inner leg, each outer leg having a side extension that is substantially perpendicular to the outer leg, the side extension having an opening formed therein for partially exposing a contact area between the outer leg and a respective one of the first and the second magnet shells.

In general, in still another aspect, the invention is directed to a housing component carrier for a housing suitable for a miniature electroacoustic transducer of a listening device. The component carrier comprises a housing component and a frame supporting the housing component, the frame having registration elements formed therein for registration of the component carrier with other component carriers. Struts are used to attach the housing component to the frame, the struts holding the housing component in a fixed position spaced apart from the frame.

In some embodiments, the housing component may be a wall section, which may include a 4-sided wall section or a wall section having a pair of opposing walls. In some embodiments, the wall section comprises at least one nonplanar wall. The wall section may also have an end wall with a recessed area formed therein, the recessed area including openings for receiving lead wires, or the wall section may have an end wall with holes formed therein for receiving lead wires.

In some embodiments, the housing component is at least one of an inner bottom plate and an outer bottom plate, with the outer bottom plate possibly being nonplanar and/or the inner bottom plate including a bent portion having holes formed therein for receiving lead wires. The inner bottom plate and the outer bottom plate define a gap therebetween that may be filled with either adhesive material, air, or the like.

In some embodiments, the housing component may be a bottom plate, or it may be a top plate. The top plate may or may not be nonplanar and may or may not have an overhang section attached to one end, the overhang section having holes formed therein for receiving lead wires. The top plate may also include a bent portion having holes formed therein for receiving lead wires, or it may not.

It is also contemplated that the housing component may be in a plane that is substantially parallel to a plane of the frame, and the component carrier may be configured so that a plurality of the component carriers may be connected together in series to form a strip of component carriers.

In general, in yet another aspect, the invention is directed to a method of assembling a housing suitable for electroacoustic transducers of listening devices. The method comprises the step of providing a first component carrier, the first component carrier carrying a first housing component therein at a fixed position. The method further comprises the step of placing the first component carrier directly adjacent to a second component carrier so that the first component carrier is in registration with the second component carrier, the registration causing a second housing component carried by the second component carrier to be automatically aligned with the first housing component. The first and second housing components are then removed as a unit from the first and second component carriers.

In some embodiments, the method may further comprise placing at least a third component carrier directly adjacent to the second component carrier so that the third component carrier is in registration with the second component carrier, the registration causing a third housing component carried by the third component carrier to be automatically aligned with the second housing component. The first component carrier may be a bottom plate carrier, the second component carrier may be a wall section carrier, and the third component carrier may be top plate carrier. Also, where the bottom plate is an inner bottom plate, the method may further comprise placing a fourth component carrier adjacent to the first component carrier, the fourth component carrier carrying an outer bottom plate.

In some embodiments, the method may further comprise preassembling a working drive and mounting the preassembled working drive on the first housing component. At least one component of the preassembled working drive may still be attached to its component carrier such that the preassembled working drive is automatically aligned to the first housing component

In some embodiments, the step of providing the first component carrier may comprise providing a strip of first component carriers, and the step of placing the first component carrier on top of the second component carrier may comprise placing a strip of first component carriers on top of a strip of second component carriers.

In some embodiments, the registration may comprise a notch in the first component carrier being aligned with a notch in the second component carrier, and step of removing the first and second housing components may comprise stamping the first and second housing components as a unit from the first and second carriers.

In some embodiments, the step of removing the first and second housing components may comprise laser cutting the first and second housing components from the first and second carriers, which step of removing may leave exposed cutting surfaces on the first and second housing components indicative of struts attaching the first and second housing components to the first and second carriers, respectively.

The above summary of the present invention is not intended to represent each embodiment, or every aspect, of the present invention.

### BRIEF DESCRIPTION OF THE DRAWINGS

The foregoing and other advantages of the invention will become apparent upon reading the following detailed description and upon reference to the drawings, wherein:

FIG. 1 illustrates exemplary components in the form of strips for an electromagnetic drive according to an embodiment of the invention;

FIGS. 2A and 2B illustrate an exemplary armature strip carrier according to an embodiment of the invention;

FIGS. 3A and 3B illustrate an exemplary lower magnet shell strip carrier according to an embodiment of the invention;

FIGS. 4A and 4B illustrate an exemplary upper magnet shell strip carrier according to an embodiment of the invention;

FIGS. 5A and 5B illustrate an assembly of an electromagnetic drive constructed according to an embodiment of the invention;

FIG. 6 illustrates a close-up view of an electromagnetic drive constructed according to an embodiment of the invention;

FIG. 7 illustrates a close-up view of the electromagnetic drive of FIG. 6 wherein openings are formed in the armature to facilitate laser welding;

FIG. 8 illustrates a receiver having an electromagnetic drive constructed according to an embodiment of the invention;

FIG. 9 illustrates another receiver having an electromagnetic drive constructed according to an embodiment of the invention;

FIG. 10 illustrates exemplary components in the form of strips for a receiver housing according to an embodiment of the invention;

FIG. 11 illustrates an exemplary wall section for a receiver housing according to an embodiment of the invention;

FIG. 12 illustrates an exemplary bottom plate for a receiver housing according to an embodiment of the invention;

FIG. 13 illustrates an exemplary top plate for a receiver housing according to an embodiment of the invention;

FIGS. 14A-14D illustrate a receiver housing having multiple bottom plates according to an embodiment of the invention;

FIGS. 15A-15B illustrate a receiver housing having nonplanar sidewalls according an embodiment of the invention; and

FIGS. 16A-16B illustrate a receiver housing having nonplanar bottom plates according an embodiment of the invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

As mentioned above, embodiments of the invention use transducer components that are in the form of carriers. In one embodiment, the component carriers facilitate automatic assembly of electromagnetic drives, such as those used in the electroacoustic transducers of listening devices (e.g., hearing aids). In another embodiment, the component carriers facilitate automatic assembly of the housing that houses the electromagnetic drives. Both embodiments may be implemented independently of one another, or they may be implemented jointly. In either case, several component carriers may be connected together in series to form strips that are then run through an automated assembly line to construct the electromagnetic drives and/or housing. Although receivers are primarily described herein, those having ordinary skill in the art will recognize that the invention is equally applicable to assembly of microphones as well and to electroacoustic transducers in general.

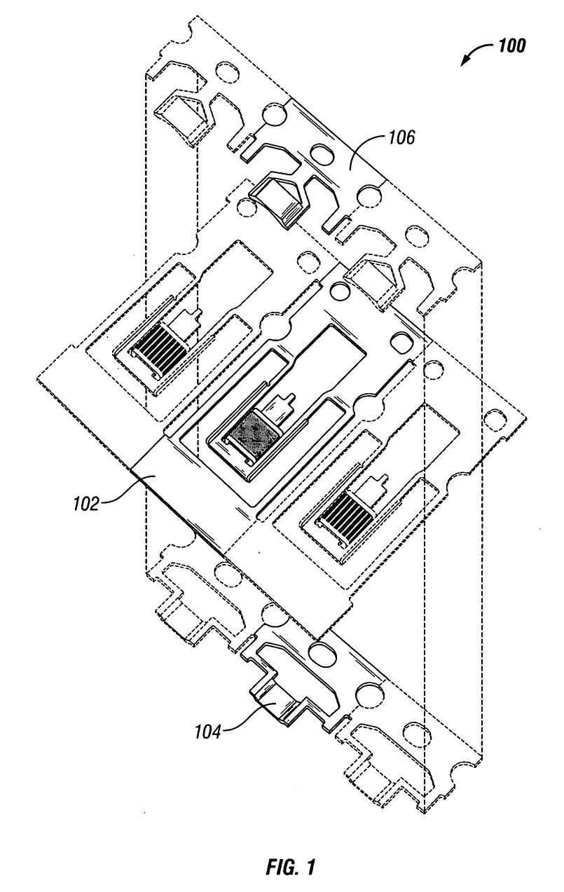

FIG. 1 illustrates several exemplary strips of component carriers that may be used to assemble an electromagnetic drive 100 for an electroacoustic transducer. As can be seen, the strips in this embodiment include an armature strip 102, a lower magnet shell strip 104, and an upper magnet shell strip 106. Although three component strips are shown here, it is of course possible to add additional strips of components or to remove one of the strips 102, 104, and 106 without departing from the scope of the invention. For example, in addition to the armature strip 102, lower magnet shell strip 104, and upper magnet shell strip 106, a component strip may be added for carrying the diaphragm or some other component of the receiver. Alternatively, in some cases, only one or both of the magnet shells, or only the armature, are provided in carrier form and the remaining components are provided in their conventional forms. Furthermore, other working drives besides the electromagnetic drive 100 may also be assembled using the component carrier system and method of the invention. Indeed, the entire receiver may be assembled using the component carrier system and method of the invention. For purposes of economy of the description, however, assembly of the electromagnetic drive 100 will be primarily described herein.

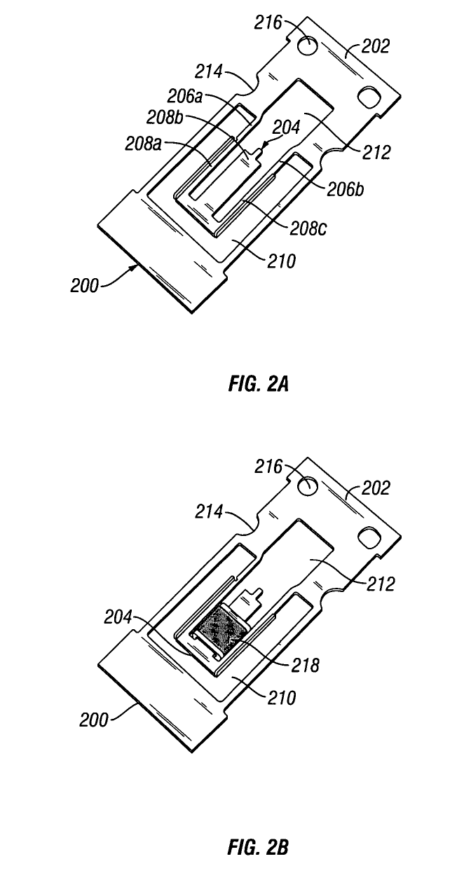

FIG. 2A illustrates one of the individual component carriers, namely, the armature carrier 200 of the armature strip 102. The armature carrier 200 includes a frame 202 that surrounds a preformed armature 204 and a pair of forwardly extending struts 206a and 206b that attach the armature 204 to the frame 202. The armature 204 is spaced apart from the frame 202 except for where the struts 206a and 206b are attached. The struts 206a and 206b hold the armature 204 in a fixed position and in a plane that is substantially parallel to the frame 202 such that the entire armature carrier 200 is generally flat. Other components may then be assembled to the armature 204 by using the frame 202 as a positioning guide or reference point. This helps ensure proper placement and alignment of any components that are mounted to the armature 204, for example, a coil assembly (see FIG. 2B). When the electromagnetic drive 100 is completely assembled, the struts 206a and 206b may be cut (i.e., singulated) to remove the armature 204, and any components mounted thereto, from the frame 202.

The function of the armature 204 is generally well known to those having ordinary skill in the art and will therefore not be discussed here. In the example shown, the armature 204 is an E-shaped armature with two outer legs 208a and 208c and an inner leg 208b. The inner leg 208b constitutes the moving part of the armature 204. Other shapes may also be used for the armature 204, for example, a U-shaped armature, without departing from the scope of the invention. The outer legs 208a and 208c and the struts 206a and 206b, together with the frame 202, define a gap 210 around a portion of the armature 204. The gap 210 helps accommodate any automated assembly equipment that might be used, for example, during the singulation of the electromagnetic drive 100 after assembly.

The frame 202 and the struts 206a and 206b also define a space 212 in the frame 202 adjacent to the moving end of the inner leg 208b. The space 212 provides room to accommodate the mounting of other components on the inner leg 208b, such as a coil assembly 218 (best seen in FIG. 2B). The mounting of the coil assembly 218 on the inner leg 208b may be done either manually or by using automated assembly equipment. In some embodiments, the coil assembly 218 includes a conductive wire wrapped around a bobbin. The bobbin is then placed over the inner leg 208b of the armature 204 so that the inner leg 208b extends through a tunnel in the bobbin. Thereafter, the bobbin is attached to the outer legs 208a and 208c (e.g., by adhesive, soldering, laser welding, etc.) of the armature 204 such that during operation, the inner leg 208b is preferably never in physical contact with the bobbin. Alternatively, or in addition, the bobbin may be attached to the magnet shells (e.g., by adhesive, soldering, laser welding, etc.) once they are mounted on the armature 204 (described below). An example of such a coil assembly may be found in commonly-owned U.S. application Ser. No. 10/756,589, entitled “Receiver Having an Improved Bobbin,” filed Jan. 13, 2004, and incorporated herein by reference in its entirety. Of course, other types of coil assemblies 218, including ones that employ a removable coil former, may certainly be used without departing from the scope of the invention.

In some embodiments, the armature carrier 200 also includes somewhat semicircular grooves or notches 214 formed on each side of the frame 202. When two or more armature carriers 200 are attached adjacent to one another in the strip 102, the grooves or notches 214 of one armature carrier 200 forms a hole (best seen in FIG. 1) with the grooves or notches 214 of the adjacent armature carrier 200. These holes may be used as indices to register the armature carrier 200, and the armature 204 therein, with other components in the electromagnetic drive 100. Other types of registration elements may also be used instead of, or in addition to, the grooves or notches 214. For example, bumps or protrusions (not shown) may be formed on the armature carrier 200 that register with indentations or holes on other component carriers. A second set of holes 216 is provided in the frame 202 near the top of the armature carrier 204 that may be used, for example, to facilitate handling and moving of the armature carrier 200 along an automated assembly line.

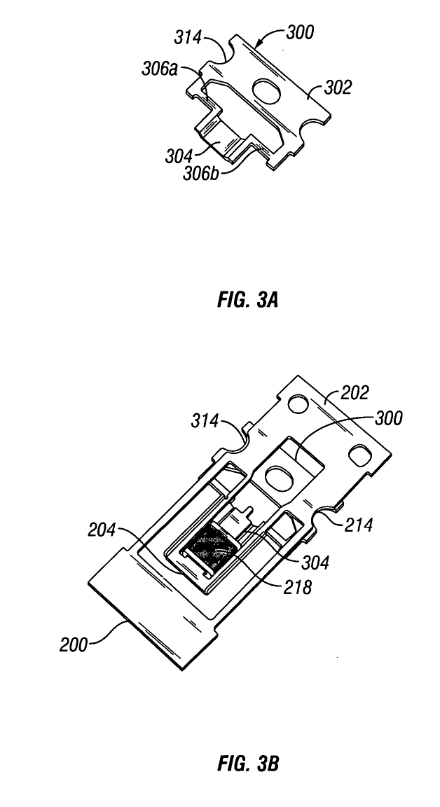

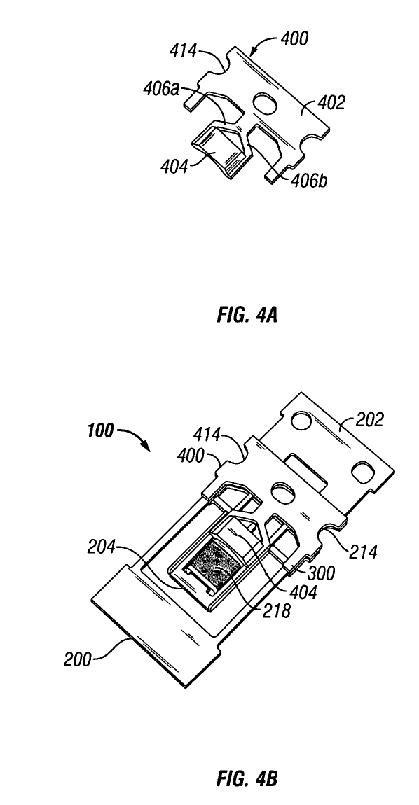

FIG. 3A illustrates an individual lower magnet carrier 300 of the lower magnet shell strip 104. As can be seen, the lower magnet carrier 300, like the armature carrier 200, includes a frame 302 and a lower magnet shell 304. Note that the frame 302 is somewhat truncated compared to the frame 202 of the armature carrier 200 in order to minimize the amount of material used. It is possible, however, for the frame 302 to be identical to the frame 202 without departing from the scope of the invention. The lower magnet shell 304, together with the upper magnet shell 404 (see FIGS. 4A-4B), form the magnet assembly of the electromagnetic drive 100. A pair of laterally extending struts 306a and 306b couple the lower magnet shell 304 to the frame 302. The struts 306a and 306b hold the lower magnet shell 304 at a fixed position and distance relative to the frame 302, thus allowing the frame 302 to be used as a positioning guide or reference point. The fixed position and distance are predefined so that the lower magnet shell 304 is directly underneath the moving end of the armature 204 when the armature carrier 200 and the lower magnet shell carrier 300 are in register.

Registration may be accomplished via the somewhat semicircular grooves or notches 314 on each side of the frame 302 of the lower magnet shell carrier 300. The grooves or notches 314 form indexing holes in the frame 302 when two or more lower magnet shell carriers 300 are attached adjacent to each other in the lower magnet shell strip 104. This is shown in FIG. 3B, where the armature carrier 200 is stacked on top of the lower magnet shell carrier 300, with the grooves or notches 214 of the armature carrier 200 aligned to the grooves or notches 314 of the lower magnet shell carrier 300. When such an aligned stacking is achieved, the lower magnet shell 304 is, automatically and precisely positioned in the proper place under the armature 204.

The upper magnet shell 404 may then be stacked on top of the armature 204 in a similar manner to that described above to complete the assembly of the electromagnetic drive 100, as illustrated in FIGS. 4A-4B. Referring first to FIG. 4A, the upper magnet shell carrier 400 is similar to the lower magnet shell carrier 300 in that it includes a frame 402 and an upper magnet shell 404. However, instead of laterally extending struts, the struts 406a and 406b in the upper magnet shell carrier 400 extend diagonally in the manner shown. The purpose of the different directions for the different struts relates to the singulation of the electromagnetic drive 100 and will be explained further below. The struts 406a and 406b hold the upper magnet shell 404 at a fixed position and distance so as to precisely align the upper magnet shell 404 directly over the moving end of the armature 204 when the armature carrier 200 is in register with the upper magnet shell carrier 400. In addition, the fixed position and distance of the upper magnet shell 404 also precisely align it directly over the lower magnet shell 304 when the upper magnet shell carrier 400 is in register with the armature carrier 200.

As before, registration may be accomplished via the somewhat semicircular grooves or notches 414 in the two sides of the frame 402 that form indexing holes when two or more of the upper magnet shell carriers 400 are attached adjacent one another. FIG. 4B shows the upper magnet shell carrier 400 stacked on top of the armature carrier 200, with the grooves or notches 414 of the upper magnet shell carrier 400 aligned to the grooves or notches 214 of the armature carrier 200. Again, instead of (or in addition to) the grooves or notches 414, other types of registration elements may also be used. This is also true for the lower magnet shell carrier 300. Regardless of how it is achieved, when the carriers 200 and 400 are aligned, the upper magnet shell 404 is automatically and precisely positioned on top of the armature 204 in the proper position. The upper magnet shell 404 is also automatically and precisely positioned on top of the lower magnet shell 304 by virtue of its alignment with the armature carrier 200. The lower upper and magnet shells 304 and 404 are then attached to the armature 204, for example, by laser welding, soldering, or adhesive, to keep the entire assembly together.

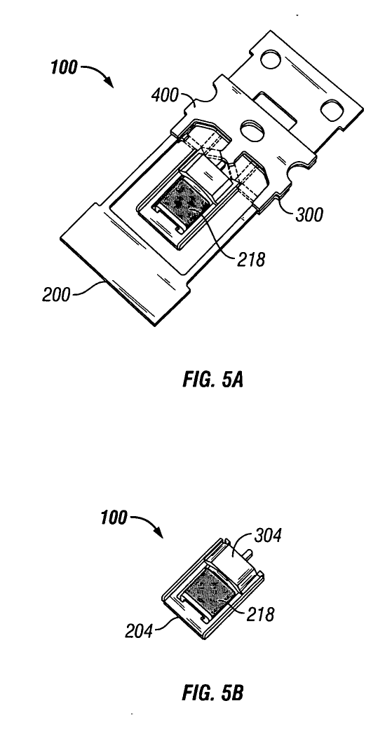

FIGS. 5A-5B illustrate the electromagnetic drive 100 in its assembled form using the armature carrier 200, lower magnet shell carrier 300, and upper magnet shell carrier 400 of the invention. Assembly may be accomplished, for example, by feeding the armature strip 102, the lower magnet shell strip 104, and the upper magnet shell strip 106 (see FIG. 1) through automated assembly equipment (not shown) that stacks the armature carrier 200, lower magnet shell carrier 300, and upper magnet shell carrier 400, on top of one another. Such automated assembly equipment is well-known to those having ordinary skill in the art and will therefore not be described here. In FIG. 5A, the struts that hold the armature 204, lower magnet shell 304, and upper magnet shell 404 are shown in dashed lines to indicate they have been severed. The severing may be done, for example, by stamping the struts, cutting them with a laser, and the like.

As mentioned above, in some embodiments, each pair of struts may extend in a different direction. In the example shown, the struts 206a and 206b extend in a forward direction, the struts 306a and 306b extend in a lateral direction, and the struts 406a and 406b extend in a diagonal direction. The different directions allow the struts to be directly exposed to the singulation tool, thus providing a cleaner severing of the struts. However, multi-directional struts are not a requirement and struts extending in only one direction may certainly be used without departing from the scope of the invention.

FIG. 5B illustrates the electromagnetic drive 100 after it has been singulated and the frames 202, 302, and 402 removed. All that remains is the armature 204, the lower magnet shell 304, the upper magnet shell 404 (not visible), and the coil assembly 218. The electromagnetic drive 100 is now ready to be incorporated into a receiver (see FIG. 7).

A close-up view of the singulated surfaces is shown in FIG. 6. Here, only a small portion (if any) of the struts 206a & 206b, 306a & 306b and 406a & 406b remains, evidenced primarily by their respective cutting surfaces that have now been exposed after singulation. As can be seen, the exposed cutting surfaces of the armature struts 206a and 206b face in a forward direction, the exposed cutting surfaces of the lower magnet shell struts 306a and 306b face in a lateral direction, and the exposed cutting surfaces of the upper magnet shell struts 406a and 406b face in a diagonal direction. The visibility of the cutting surfaces of the struts 206a & 206b, 306a & 306b and 406a & 406b, while not necessarily conclusive, is often a good indicator that the struts were previously attached, but have now been cut. This is particularly true if the cutting surfaces are jagged or scarred, indicating that some type of stamping tool may have been used to cut the struts 206a & 206b, 306a & 306b and 406a & 406b.

In the embodiments shown thus far, the two outer legs 208a and 208c of the armature 204 each have a side extension that runs along the length of the outer legs 208a and 208c. FIG. 7 shows the electromagnetic drive 100 with the upper magnet shell 404 removed in order to illustrate the side extensions 700a and 700b more clearly. The side extensions 700a and 700b extend outwardly from the outer legs 208a and 208c and curve in an upward direction (or downward, depending on the view) so that they are substantially perpendicular to the outer legs 208a and 208c. The purpose of the side extensions is to provide extra stiffness for the armature as well as to increase the flux that flows through the armature.

Unfortunately, the side extensions 700a and 700b can pose a problem in certain situations. As mentioned above, one of the ways to attach the armature 204 to the lower and upper magnet shells 304 and 404 is by laser welding. Typically, the laser is applied along the visible area where the magnet shells 304 and 404 contact the outer legs 208a and 208c. However, because the side extensions 700a and 700b extend substantially perpendicular to the outer legs 208a and 208c, they can obstruct the path of the laser to the contact area between the outer legs 208a and 208c and either the upper or lower magnet shell 304 or 404.

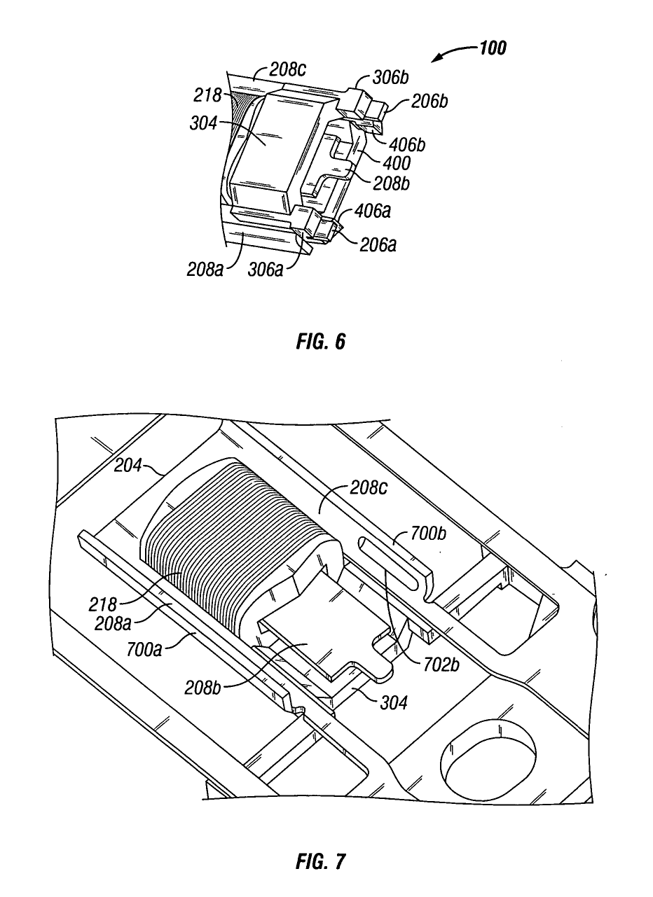

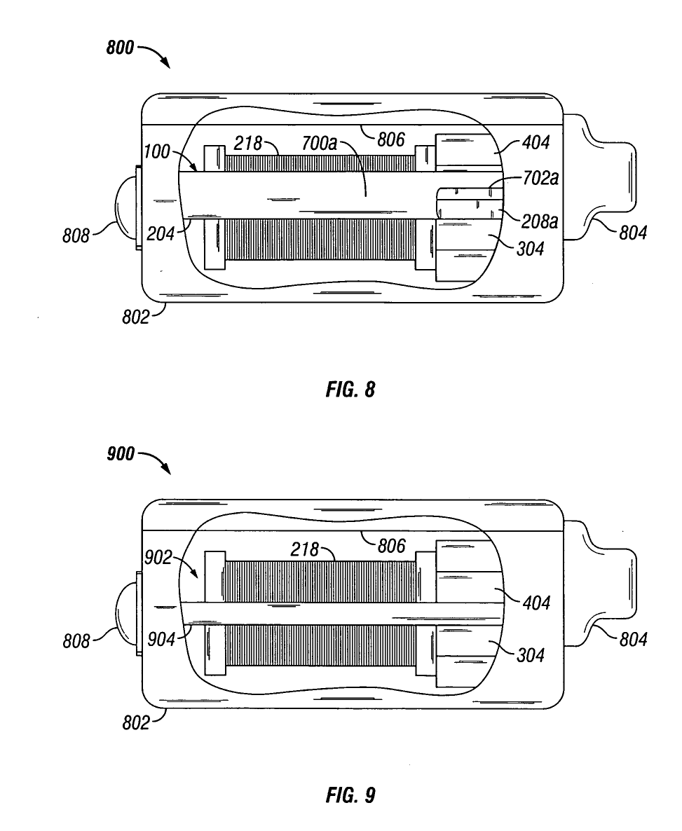

Therefore, in accordance with one embodiment of the invention, openings 702a and 702b are formed in the side extensions 700a and 700b. Due to the particular viewing angle of FIG. 7, only the opening 702b in the second side extension 700b is visible here (the other opening 702a can be seen in FIG. 8). The openings 702a and 702b in the side extensions 700a and 700b partially expose the contact area between the magnet shells 304 and 404 and the outer armature legs 208a and 208c such that a laser may then be aimed through the openings 702a and 702b to weld the magnet shells 304 and 404 to the outer legs 208a and 208c.

FIG. 8 illustrates a receiver 800 having the electromagnetic drive 100 mounted therein according to embodiments of the invention. The receiver 800 includes a housing 802 that protects the sensitive components inside the receiver 800. The housing 802 is preferably of a small enough size and shape that allows the receiver 800 to be used in miniature listening devices, such as hearing aids. Within the housing is a diaphragm 806 that converts the movements of the armature 204 into acoustic signals that are then broadcast to the user via an outlet 804. The diaphragm 806 is typically connected to the armature 204 via a drive pin (not shown). Lead wires from the coil assembly 218 of the electromagnetic drive 100 extend through an opening in the housing 802 and terminate at a terminal 808 on the outside of the receiver 800.

In accordance with embodiments of the invention, the electromagnetic drive 100 is constructed using components that are provided on component carriers of the type described above, including the armature 204, the lower magnet shell 304, and the upper magnet shell 404. As a result, the armature 204, the lower magnet shell 304, and the upper magnet shell 404 have exposed cutting surfaces (see FIG. 6) that are indicative of previously attached struts which were cut during singulation. In some embodiments, the diaphragm 806 may also be in the form of a component carrier of the type described above. The foregoing arrangement facilitates automatic assembly of the receiver 800 by making the individual components of the receiver 800 quickly and efficiently mountable to one another and precisely and properly aligned with respect to one another.

One of the outer legs 208a of the armature 204 can be seen through the opening 702a of the side extension 700a for laser welding purposes. Of course, the openings 702a and 702b are not needed if laser welding is not used, or if the armature 204 is of the type that has no side extensions 700a and 700b on its outer legs 208a and 208c. An example of such an armature is shown in the receiver 900 of FIG. 9. As can be seen, the receiver 900 is essentially identical to the receiver 800 of FIG. 8, except that the electromagnetic drive 902 therein has an armature 904 with no side extensions. As a result, laser welding of the lower and upper magnets 304 and 404 to the armature 904 (as well as other tasks) may be performed in an unobstructed manner in this embodiment.

Thus far, the description has mainly focused on the construction of the electromagnetic drive. Following now is a discussion of a housing that may be constructed according to an embodiment of the invention. It should be noted that the housing may be either a receiver housing or a microphone housing, although a receiver housing is primarily described herein for purposes of economy of the description. Referring to FIG. 10, a receiver housing 1000 is shown that may be constructed using automatically aligning components strips. The component strips may include a wall section strip 1002, a bottom plate strip 1004, and a top plate strip 1006. While three component strips 1002, 1004, and 1006 are shown here, it is of course possible to add additional components strips or to remove one of the component strips 1002, 1004, or 1006 without departing from the scope of the invention. For example, in some embodiments, the wall section strip 1002 may be replaced with conventional wall sections.

Each component strip 1002, 1004, and 1006 may include a plurality of component carriers connected together in series. In one implementation, the wall sections strip 1002 may include a plurality of wall section carriers 1008 connected together in series. Likewise, the bottom plate strip 1004 may include a plurality of bottom plate carriers 1010 connected together in series, and the top plate strip 1006 may include a plurality of top plate carriers 1012 connected together in series. 1781 Similarly, each component carrier 1008, 1010, and 1012 may carry a respective housing component. For example, the wall section carrier 1008 may carry a wall section 1014, the bottom plate carrier 1010 may carry a bottom plate 1016, and the top plate carrier 1012 may carry a top plate 1018. Each housing component 1014, 1016, and 1018 is attached to its respective component carrier by struts 1020, 1022, and 1024, as shown. When the component carriers 1008, 1010, and 1012 are properly positioned on top of one another, their respective components 1014, 1016, and 1018 are automatically aligned relative to one another in a manner similar to that described above with respect to the electromagnetic drive 100.

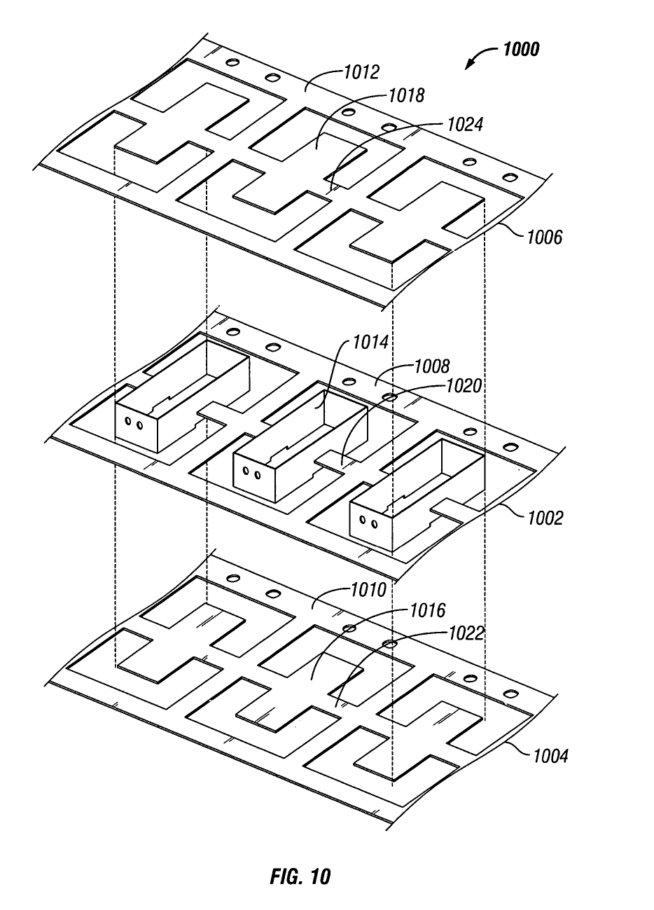

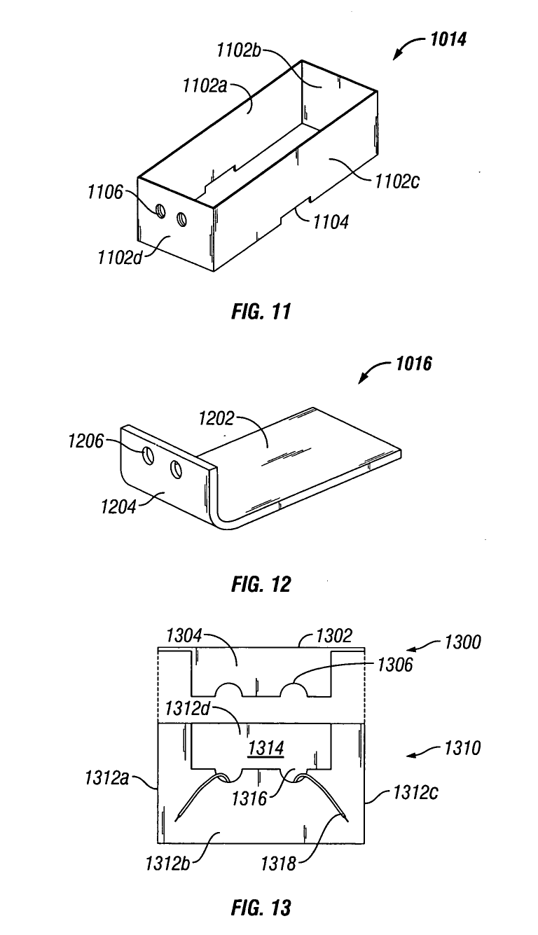

FIG. 11 illustrates the exemplary wall section 1014 of the wall section carrier 1008 in more detail. As can be seen, the wall section 1014 includes two side walls 1102a and 1102c and two end walls 1102b and 1102d, all connected to one another in a substantially rectangular configuration. The wall section 1014 may be made of any suitable material, including Mu-metal (e.g., 80Ni-16Fe-4Mo). Each of the two sidewalls 1102a and 1102c preferably has a slit 1104 formed in the bottom edge thereof for receiving the struts 1022 (see FIG. 10) that connect the bottom plate 1016 to the bottom plate carrier 1010. Ideally, the fit between the slits 1104 and the struts 1022 has just enough tolerance to be snug. A set of holes 1106 may be formed in one of the end walls, for example, the end wall labeled as 1102b. When present, these holes 1106 can receive lead wires (see FIG. 13) that extend from the electromagnetic drive 100.

FIG. 12 illustrates one exemplary implementation of the bottom plate 1016 of the bottom plate carrier 1010 in more detail. The bottom plate 1016 may be made of any suitable material, including the same material as the wall section 1014. In most implementations, the bottom plate 1016 is simply a flat plate that it is disposed underneath the wall section 1014 (as shown in FIG. 10). However, in the exemplary implementation shown here, the bottom plate 1016 is a flat plate 1202 having one of its ends, for example, the end labeled as 1204, bent upward at approximately 90°. A set of holes 1206 may then be formed in the end 1204 corresponding to the holes 1106 of the wall section 1014. The lead wires from the electromagnetic drive 100 may thereafter be threaded through both sets of holes 1106 and 1206 during assembly of the receiver housing 1000. As mentioned above, however, it is also possible to use a simple flat surface with no bend and no holes as the bottom plate 1016. Similarly, the top plate 1018 (see FIG. 10) may also be a simple flat surface, or it may have a downward bend at one end with sets of holes formed therein for receiving lead wires. In either case, the top plate 1018 of the top plate carrier 1012 may then be placed on top of the wall section 1014, and the entire receiver housing 1000 may be held together using adhesives, soldering, welding, and the like.

In some embodiments, no lead wire holes 1106 are formed in the wall section 1014. Instead, the lead wires are threaded through semicircular openings in the wall section and the top plate. An example of such a top plate 1300 and wall section 1310 may be seen in FIG. 13. The top plate 1300 is similar to the top plate 1018 of FIG. 10 in that it has an essentially flat surface 1302. Likewise, the wall section 1310 is similar to the wall section 1014 of FIG. 10 in that it has two sidewalls 1312a and 1312c and two end walls 1312b and 1312d connected together in a substantially rectangular configuration.

In addition, the top plate 1300 also has a substantially rectangular overhang 1304 that includes a set of semicircular openings 1306 formed therein. The rectangular overhang 1304 is designed so that it fits snugly into a substantially rectangular recess 1314 formed in one of the end walls, for example, the end wall labeled as 1312b. The substantially rectangular recess 1314 has a set of semicircular openings 1316 that corresponds to the semicircular openings 1306 in the overhang 1304 of the top plate 1300. When mated, the two sets of semicircular openings 1306 and 1316 form holes through which the lead wires 1318 may be subsequently threaded. Preferably, the two sets of semicircular openings 1306 and 1316 align with the openings 1206 in the bottom plate 1016 (when such openings 1206 are present). 1831 An exemplary method for assembling one or more receiver housings 1000 according to embodiments of the invention will now be described. First, an electromagnetic drive 100 for each housing 1000 needs to be assembled, although it possible to use electromagnetic drives that are already fully assembled. The electromagnetic drives 100 may be assembled using the component strips in the manner described above, except that it is not necessary for them to be completely singulated from the component strips immediately after assembly. Then, place the strip(s) with the assembled electromagnetic drives 100 on the component strip 1004 that holds the bottom plates 1016 for the receiver housings 1000, and attach the electromagnetic drives 100 to the bottom plates 1016 (e.g., by adhesive, soldering, welding, etc). Next, separate the electromagnetic drives 100 from their strips (e.g., by cutting, stamping, etc.) while the bottom plates 1016 are still attach to their carriers 1010.

Wall sections 1014 may then be placed over the electromagnetic drives 100 and onto the bottom plates 1016. The wall sections 1014 may also be in a strip 1002 to be singulated at a later stage. In some embodiments, each wall section 1014 may be fortified with fortification ribs (not expressly shown) at one or more comers. The wall sections 1014 may also have a print plate that is already assembled on the backside of the wall section 1014. Preferably, the wall sections 1014 have slits 1104 that snap snuggly onto the struts 1022 of the bottom plates 1016. If applicable, the wall sections 1014 may now be singulated from their carriers 1008 and secured to the bottom plates 1016 (e.g., by adhesive, soldering, welding, etc.).

Since the bottom plates 1016 are still attached to their carriers 1010, the entire assembly may be transported or handled while remaining attach to the bottom plate strip 1004. Examples of such handling may include manual coil handling where the lead wires are soldered to the print plate. Thereafter, the bottom plates 1016 may be separated from their carriers 1010 (e.g., by cutting, stamping). Other steps that may be performed at this point include magnetically charging the magnets and placing the movable armature leg in the magnetic center, placing the diaphragms on the receiver housings 1000 (e.g., by cutting/stamping them from their carriers, if a diaphragm strip is used), and placing the top plates 1018 on the wall sections 1014 in a manner similar to that described above with respect to the wall sections 1014 and the bottom plates 1016.

Note that in the foregoing method not all manufacturing steps are described, such as mounting the drive pin and soldering the lead wires to the coil, since a person of ordinary skill in the art is likely to be already familiar with these steps. For example, U.S. Pat. No. 6,763,571, which is incorporated herein by reference, discloses a drive pin that may be used in the housings 1000. Moreover, variations to the above method exist, for example, by performing the above steps in a different order (e.g., assembling the electromagnetic drives 100 into the wall sections 1014 before placing the bottom and top plates 1016 and 1018 on the receiver). Similarly, it is possible to mount the diaphragms to the top plates 1018 first instead of to the wall sections 1014.

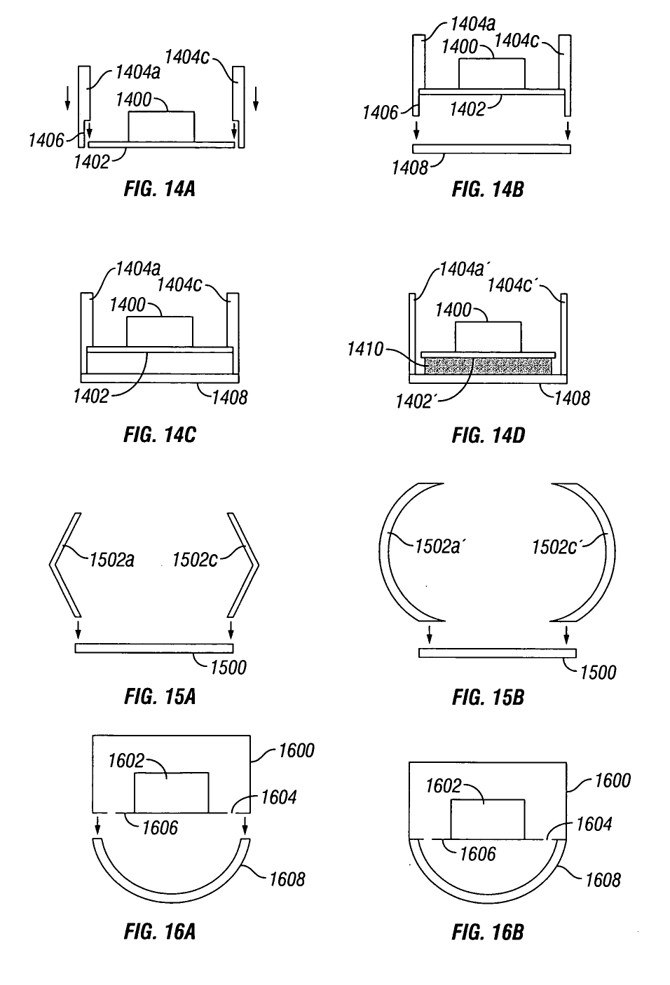

FIGS. 14A-D illustrate further embodiments of the invention where more than one bottom plate may be used in a receiver (or microphone) housing. Here, only the housing components themselves are shown and not the component carriers, although a person of ordinary skill in the art will readily recognize that the principles and concepts discussed previously are equally applicable. In FIG. 14A, an electromagnetic drive 1400 is placed on an inner bottom plate 1402. Also present is a wall section, although only the two sidewalls 1404a and 1404c of the wall section are shown for convenience purposes. It is possible, of course, to provide only two opposing sidewalls initially while the bottom plate 1402 is being mounted, then add the remaining sidewalls at a later time. Each sidewall 1404a and 1404c, and possibly all four walls in some embodiments, includes a recessed area 1406 that extends upward from the bottom edge of the sidewalls 1404a and 1404c. The recessed areas 1406 allow the inner bottom plate 1402 to be mounted about a third of the way up the sidewalls 1404a and 1404c. Then, an outer bottom plate 1408 may be attached to the bottom of the wall section, as shown in FIG. 14B, resulting in a gap between the two bottom plates 1402 and 1408. The gap may be an air gap (shown in FIG. 14C), or it may be filled with an appropriate filler, such as an adhesive 1410 (shown in FIG. 14D). Where an adhesive 1410 is used, sidewalls 1404a′ and 1404c′ that do not have a recessed area may be used instead of the previously discussed sidewalls 1404a and 1404c. Similarly, a somewhat narrower bottom plate 1402′ may be used instead of the inner bottom plate 1402 mentioned earlier, since it is not necessary for the bottom plate 1402′ to extend all the way to the sidewalls.

Other embodiments of the invention provide the use of sidewalls that are nonplanar, such as the angular sidewalls 1502a and 1502c shown in FIG. 15A and the rounded sidewalls 1502a′ and 1502c′ shown in FIG. 15B. Note that although only two sidewalls are shown in FIGS. 15A-B for convenience purposes, it is of course possible for all four sidewalls to be nonplanar.

Moreover, the outer bottom plate may also have a nonplanar shape, as shown in FIGS. 16A-B. In these embodiments, a receiver housing 1600 having an electromagnetic drive 1602 housed therein is provided with openings 1604 in the inner bottom plate 1606. A nonplanar outer bottom plate 1608 may then be attached to the inner bottom plate 1606, for example, via welding, soldering, or gluing. By virtue of its nonplanar (e.g., semicircular) shape, the outer bottom plate 1608 provides additional back volume for the receiver.

A number of advantages may be derived from the various embodiments of the invention described above. For example, a subassembly is provided for manual handling (if necessary) on strips, which makes handling easier. The invention also allows for an almost symmetrical design of a receiver. In addition, with regard to the flux path, the flux lines through the bottom and top plates of the receiver may be nearly the same, which may lower magnetic radiation.

The invention also lowers magnetic radiation by providing multiple bottom plates. As is well known to those having ordinary skill in the art, welding the electromagnetic drive to the traditional housing may result in a mechanically stable receiver, but the magnetic radiation may increase. On the other hand, gluing the electromagnetic drive to the housing may result in lower magnetic radiation, but the mechanical stability of the electromagnetic drive may be less. Embodiments of the invention provide a solution to this problem by providing, for example, two bottom plates: one to assemble the motor on, and another one to decrease magnetic radiation. This can be achieved by assembling both bottom plates directly on top of each other (if appropriate material is used), or by having a distance between the two plates with the area between them filled with air, adhesive, or other material. Thus, the invention makes it possible to weld the electromagnetic drive onto the inner bottom plate, and still not increase the magnetic radiation. Of course, a person having ordinary skill in the art will understand that the above described solution for the magnetic radiation can also be applied when a traditional receiver housing is used, namely, by using an additional plate in the housing bottom on which to assemble the electromagnetic drive.

Other advantages include more accurate positioning of the electromagnetic drive on the bottom plate and an increase in the number of production steps in the manufacturing process of a receiver that can be done automatically. Easier access to the inside of the receiver housing is also available, both during and after assembly (e.g., in a repair situation), since the bottom and top plates are not assembled onto the wall section in either instance. It is also easier using embodiments of the invention to make a receiver with differently shaped sidewalls and bottom plates, with the additional advantage that the bent bottom plate may provide for additional reduction of magnetic radiation as described above. As can be seen in FIGS. 16A-B, the volume directly above the outer bottom plate 1608 is in connection with the interior of the receiver through openings 1604 in the inner bottom 1606 plate of the receiver housing 1600, allowing for additional back volume. The nonplanar shape of the outer bottom plate 1608 shown in FIGS. 16A-B may also be applied to the top plate, allowing for additional front volume as well.

On the other hand, the present invention may also be used to provide a flat bottom plate if desired. For example, because of the deep drawing process that is presently used in many manufacturing processes, the bottom plate is not always flat, which makes further manufacturing/handling of the receiver more difficult. Therefore, if desired, the present invention may be used to provide flat bottom plates that are more easily handled.

While the present invention has been described with reference to one or more particular embodiments, those skilled in the art will recognize that many changes may be made thereto without departing from the spirit and scope of the present invention. For example, the principles and concepts described herein may be equally applicable to the assembly of all electroacoustic transducers, including microphones as well as receivers. Therefore, each of these embodiments and obvious variations thereof is contemplated as falling within the spirit and scope of the claimed invention, which is set forth in the following claims.

What is claimed is:

1. An electromagnetic drive component carrier suitable for a miniature electroacoustic transducer of a listening device, comprising:
an electromagnetic drive component;
a frame supporting said electromagnetic drive component, said frame having registration elements formed therein for registration of said component carrier with other component carriers; and
struts attaching said electromagnetic drive component to said frame, said struts holding said electromagnetic drive component in a fixed position spaced apart from said frame.

2. The electromagnetic drive component carrier according to claim 1, wherein said electromagnetic drive component is an armature.

3. The electromagnetic drive component carrier according to claim 2, wherein said armature is an E-shaped armature.

4. The electromagnetic drive component carrier according to claim 3, wherein said frame includes an access area for allowing a coil assembly to be mounted on said E-shaped armature.

5. The electromagnetic drive component carrier according to claim 2, wherein said armature is a U-shaped armature.

6. The electromagnetic drive component carrier according to claim 1, wherein said electromagnetic drive component is a magnet shell.

7. The electromagnetic drive component carrier according to claim 1, wherein said struts extend in a different direction for each type of electromagnetic drive components attached to said frame.

8. The electromagnetic drive component carrier according to claim 1, wherein said struts extend in a same direction for each type of electromagnetic drive components attached to said frame.

9. The electromagnetic drive component carrier according to claim 1, wherein said electromagnetic drive component is in a plane that is substantially parallel to a plane of said frame.

10. The electromagnetic drive component carrier according to claim 1, wherein said component carrier is configured so that a plurality of said component carriers may be connected together in series to form a strip of said component camers.

11. A method of assembling a working drive suitable for electroacoustic transducers of listening devices, comprising:
providing at least a first component carrier, said first component carrier carrying a first working drive component therein at a fixed position;
placing said first component carrier directly adjacent to at least a second component carrier so that said first component carrier is in registration with said second component carrier, said registration causing a second working drive component carried by said second component carrier to be automatically aligned with said first working drive component; and
removing said first and second working drive components as a unit from said first and second component carriers.

12. The method according to claim 11, further comprising placing at least a third component carrier directly adjacent to said first component carrier so that said third component carrier is in registration with said first component carrier, said registration causing a third working drive component carried by said third component carrier to be automatically aligned with said first working drive component.

13. The method according to claim 12, wherein said working drive is an electromagnetic drive and said first component carrier is an armature carrier, said second component carrier is a lower magnet shell carrier, and said third component carrier is an upper magnet shell carrier.

14. The method according to claim 11, wherein said step of placing said first component carrier directly adjacent to said second component carrier results in said first and second component carriers being in physical contact with one another.

15. The method according to claim 11, further comprising pre-assembling a working drive subassembly and mounting said preassembled working drive subassembly on said first working drive component.

16. The method according to claim 11, wherein said step of providing said first component carrier comprises providing a strip of said first component carriers.

17. The method according to claim 16, wherein said step of placing said first component carrier on top of said second component carrier comprises placing a strip of said first component carriers on top of a strip of said second component carriers.

18. The method according to claim 11, wherein said registration comprises a notch in said first component carrier being aligned with a notch in said second component carrier.

19. The method according to claim 11, wherein said step of removing said first and second working drive components comprises stamping said first and second working drive components as a unit from said first and second carriers.

20. The method according to claim 11, wherein said step of removing said first and second working drive components comprises laser cutting said first and second working drive components from said first and second carriers.

21. The method according to claim 11, wherein said step of removing said first and second working drive components leaves exposed cutting surfaces on said first and second working drive components indicative of struts attaching said first and second working drive components to said first and second carriers, respectively.

22. A housing component carrier for a housing suitable for a miniature electroacoustic transducer of a listening device, comprising:
a housing component;
a frame supporting said housing component, said frame having registration elements formed therein for registration of said component carrier with other component carriers; and
struts attaching said housing component to said frame, said struts holding said housing component in a fixed position spaced apart from said frame.
